(19) United States
(12) Patent Application Publication
(10) Pub. No.: US 2002/0040113 A1
(43) Pub. Date: Apr. 4, 2002

(54) PROCESS FOR PRODUCING POLYETHYLENE OF VERY HIGH MOLECULAR WEIGHT AND METHOD FOR ACTIVATING THE CATALYST SUPPORT

(76) Inventors: GERD FRITZSCHE, QUERFURT (DE); HEINZ-JURGEN KERRINNES, HALLE (DE); CHRISTIAN KREMTZ, HALLE (DE); KLAUS MILOWSKI, HALLE (DE)

Correspondence Address: HORST M KASPER, 13 FOREST DRIVE, WARREN, NJ, 07059

(21) Appl. No.: 09/297,842

(22) PCT Filed: Oct. 24, 1997
(86) PCT No.: PCT/DE97/02475

(30) Foreign Application Priority Data
Nov. 7, 1996 (DE) 196 45 939.7

(51) Int. Cl. C08F 2/00

(52) U.S. Cl. 526/129; 526/348.6; 526/901; 526/352

(57) ABSTRACT

The present invention relates to a process for producing polyethylene of very high molecular weight and a method for activating the catalyst support. The parameters related to the gaseous phase fluidized bed process were determined: the temperature in the reactor, the speed of the cycle gas, the effective time of retention inside the reactor and the concentration values of buten-1 and CO2 in the cycle gas. It also relates to a thermal activation method specially intended for silicate carriers of the chromocen catalyst (the mass loss is coupled with the temperature).

This invention relates to a process to produce ultra-high molecular polyethylene using a chromocene carrier catalyst in the gas phase of a fluidized bed.

Ultra-high molecular ethylene polymers and technological processes for their production in the presence of transition metal catalysts such as Ziegler or Philips catalysts are already known.

Such processes can produce ethylene homopolymers or copolymers in a density range from 0.915 to 0.955 g/cm³ and with an average molecular weight of >1×10⁶ g/mole of grit grade. The reaction in the gas phase takes place in an intermixed bulk bed of small-size polymer whereby the reaction heat is carried off through cooling of the recycled reaction gas [Ullmanns Encyklopäadie der technischen Chemie 4 (Ullmann's encyclopedia of engineering chemistry 4) (1980), (19), p. 186; EP 0230019; EP 0260647; DE 3833444; DE 3833445].

The process takes place in the presence of a precipitation catalyst containing titanium, and sometimes additionally in the presence of an antistatic agent to avoid reactor wall fouling and product contamination, and to achieve a higher bulk density of around 450 g/l.

It is further known that ultra-high molecular polyethylene of higher bulk density is produced in the presence of a mixed catalyst of an Al-organic compound with a titanium compound which is made through reduction of a Ti-[IV]-compound whereby the reduction product is then treated with an Al-organic compound [EP 0645403, DE 4332786].

It is further known that spherical polymer particles of very good flowability and partially very high molecular weights with an MFI (190C /5 kg) around 0.05 g/10 mins. can be produced using a highly active Ziegler-Natta catalyst, whereby the catalyst is obtained by first converting di-(organo)-Mg compounds into a solid with aluminium triethyl and 1-chloropropane, and by subsequent adding of traces of titanium chlorides (DE 3620060). Another known process to produce ultra-high molecular polyethylene with a molecular weight of 1 mio. g/mole or more, a density between 0.940 and 0.950 g/cm³ and of high impact strength is characterized by use of a mixture of AlR₂X and Al (OR) RX in a mixed catalyst of an alkyl aluminium component and titanium tetrachloride (DE 2724096).

Furthermore, a process is known to produce a Ziegler-type catalytic system as well as the production of polyethylene of an extremely high molecular weight (1 to 3.5 mio g/mole) with this catalyst whereby the Ziegler-type catalyst is made through impregnation of a specific aluminium oxide with a titanium halogenide and subsequent activation with trialkyl aluminium (DE 3837524).

According to EP 0643078, ultra-high molecular ethylene homopolymers with a molecular weight of 1.8 to 3.5 mio. g/mole or ethene-α olefin copolymers with a molecular weight of ca. 2 mio. g/mole can be produced using metallocene-type compounds of titanium, zirconium or hafnium with bridged substituted cyclopentadienyl ligands in the presence of alumoxane.

It is further known that such metallocene-type compounds of titanium, zirconium or hafnium with bridged or unbridged substituted cyclopentadienyl ligands are of advantage when used in the presence of alumoxane activators in polar aprotic solvents as a suspending agent for the synthesis of ultra-high molecular polyethylene (such as with a molecular weight of 2.3 mio. g/mole to 2.8 mio. g/mole) (DE 4017331), and that besides Ti catalysts also Cr containing solid catalysts with a narrow molecular weight distribution can be used to produce homopolymers and copolymers of ethylene with a high to very high molecular weight in a melt flow index range from 0 to 1,000 dg/min. (ASTM-D-1238-62 T), specifically based on organochromium compounds of different oxidation states and various ligands on inorganic carriers. Active catalyst solids are obtained by supporting chromocene on activated silica, which provide ethene homopolymers and copolymers with a olefins through the gas phase fluidized bed technology in a wide molecular weight range and up to very high molecular weights (MFI 0) at a narrow molecular weight distribution and in the absence of internal and end double-bonds (U.S. Pat. No. 3,709,853; DE 1808388).

By adding silanes to said carrier catalysts of chromocene and silica, the catalyst productivity can be improved without any subsequent effect on the physical properties of the polymers thus produced. Polymers thus produced include materials with a density of approximately 0.950 to 0.960 g/cm³, a melt flow index of about 0.01 or more, and a chromium content in the polymer of ≦1 ppm (DE 2113965).

When such varying organo-Cr compounds are supported on inorganic carriers, subsequently thermally aged, e.g. for 0.5 to 3 hrs. at a temperature of 135C to 900C, preferably however at 300C to 700C, and optionally treated with an Al-organic compound, homopolymers and copolymers of ethylene with the following characteristics can be produced (U.S. Pat. No. 3,806,500; DE 2336227):

density: 0.945 to 0.970 g/cm³; melt flow index: 0 (no flow) to 30 g/10 mins; analytically detectable carbon/carbon double bond content, and polymer side chain branching (0.21 to 1.02 CH₃/100 C).

Furthermore, modified chromocene carrier catalyst systems are known which are obtained by the addition of an oxidant to a carried chromocene catalyst or by loading of a fine carrier with an oxidant and subsequent addition of chromocene plus subsequent addition of a reducing agent. Such systems can produce polymers of olefins in the gas phase, in a suspension, in liquid monomers or in inert solvents.

These polymers are characterized by a wide molecular weight distribution and a high density. An ultra-high molecular polyethylene with an intrinsic viscosity η of 20.6 dl/g and a density of 0.942 g/cm³ is also available (DE 4306105).

Furthermore, a polymerization catalyst is known to produce polyolefins, such as polyethylene, for polymers with a wide molecular weight distribution whereby the catalyst is made by applying a cyclopentadienyl chromium derivative of the RCrL formula to a phosphate containing oxidic carrier and on a metal complex of the formula MR³R⁴R⁵R⁶ (M═Ti, Zr or Hf) and whereby polymerization is conducted by way of solvent, slurry or gas phase technique. The polymers thus formed have MFI values in the range from 0.001 to 100 g/10 mins. (190C; 2.16 kg) (EP 0501672).

Other carriers used for chromocene are phosphate containing oxidic carriers, such as silica or aluminium oxides, to produce polyethylenes of a wide polymer mass range with such chromocene carrier catalysts by way of the slurry polymerization technique. Ultra-high molecular ethylene polymers of a molecular weight of minimum 3 mio. g/mole and with a high degree of methyl branchings of minimum 0.4 mole % methyl branchings can be formed (EP 0090374).

Furthermore, a process is known to produce ethene homopolymers and copolymers whereby a carrier catalyst is used which is formed by applying a chromium and hydrocarbon complex compound of the R Cr A Cr R formula preferably with cyclooctatetraene ligands onto a fine, porous anorganic-oxidic carrier solid, and which is activated by means of an aluminium-organic compound, if need be. The polymers thus obtained have a bulk density of ca. 370 to 450 g/l and a molecular weight of a very wide range up to an MFI (190C/21.6 kg) of 0.5 g/10 mins. (DE 3030055).

A variety of processing techniques is known for ultra-high molecular polyethylene. Known conventional techniques include sintering under pressure and ram extrusion. Also, injection moulding has been used to an increasing extent to process ultra-high molecular polyethylene (Kunststoffe 85 (1995), 4, pp. 477 to 481; Kunststoffe 83 (1993), 10, pp. 775 to 777; Kunststoffe 81 (1991), 9, pp. 809 to 811).

Also the gel spinning process to make high-strength ultra-high molecular polyethylene fibres is well known (Plastverarbeiter 1991, 42 (12), 46-47; JP 59232123).

The majority of the known polymerization processes to produce ultra-high molecular polyethylene focusses on making small particles sizes with a narrow distribution, clearly below 0.42 mm average polymer particle diameter of optimum bulk density in a molecular weight range of >1×10⁶ g/mole.

In most cases, various treatments are required in addition to keep the bulk density of the polymer grits at an optimum level for efficient product processing.

It is desirable to have processes of a simple design for variable particle size ranges also in the polymer particle range of >0.42 mm, while maintaining a uniform very high bulk density level and the desired ultra-high molecular level of molecular weight.

It is the intention of this invention to produce an ultra-high molecular, highly viscous polyethylene which is suited for pressure sintering and ram extrusion and which is characterized by easy handling, optimum mould filling, variable thickness and largely smooth mould surface of the moulded part, while maintaining a homogeneous property level above the mould volume. It was the task of the invention to develop a manufacturing process for an ultra-high molecular polyethylene of improved flowability in a grit form which is characterized by the selection of the average particle size in the >0.42 mm range on a constantly increased bulk density level, and to develop a process method for catalyst carrier activation.

It was another task to obtain an improved viscosity parameter at a given molecular weight and density level while guaranteeing the required processing stability

According to the invention, this task is solved by adjusting the velocity of the reaction circulation gas of the polymerization reaction in the gas phase fluidized bed process between 0.70 m/sec. and 0.88 m/sec., by adjusting the polymerization temperature between 85C and 100C and the average minimum retention time, expressed as the ratio of polymer bed mass to the polymer mass continuously discharged from the reactor, of 3.1 hrs., by adjusting a 1-butene concentration in the reaction circulation gas as a function of the partial pressure ratio 1-butene/ethene of 2.5·10⁻⁴ to 25·10⁻⁴ mole/mole or of 100 ppm to 1,000 ppm 1-butene respectively, and a CO₂ concentration of 1.2 to 10 ppm while at the same time preventing wall fouling in the whole reactor circulation gas system and while at the same time keeping constant the fluidizing bed densities in the reaction zone as such. The invention is further characterized by activating silica for the production of the chromocene silica catalyst solid so that the mass loss from thermal activation of the silica is first adjusted to 3.1 percent by weight to 4.8 percent by weight, that the mass loss rate is highest in this phase at a temperature between 37C and 50C, that no further mass loss occurs when the temperature reaches 132C to 138C and that the mass loss is then adjusted to 0.45 percent by weight to 1.9 percent by weight at further temperature rise and that the mass loss rate is highest in this phase at a temperature between 410C and 440C and that no further mass loss occurs from 520C to 540C and that the highest temperature reached should not exceed 580C and that the silica carrier thus activated, after thermal carrier activation, should be loaded only with such an amount of chromocene that the chromium content in the dry catalyst solid is adjusted between 0.9 and 1.1 percent by weight.

The polymerization reaction in the gas phase fluidized bed process is preferably adjusted so that the velocity of the reaction circulation gas is 0.74 m/sec. to 0.85 m/sec., that a polymerization temperature is selected in the range between 87C and 95C and that a 1-butene concentration equivalent to a partial pressure ratio 1-butene/ethene between 6.0·10⁻⁴ mole/mole and 11·10⁻⁴ mole/mole or 500 ppm to 800 ppm of 1-butene respectively and a CO₂ concentration between 1.5 ppm and 4.5 ppm are measured in the reaction circulation gas.

After the charging the carrier with the organochromium compound, the separated catalyst solid is dosed direct into the fluidized bed polymerization process without thermal ageing. Catalyst productivity under the polymerization process conditions of the invention is minimum 5 tonnes of polyethylene per kg of catalyst solid, preferably however 5.7 to 12.5 tonnes of polyethylene per kg of catalyst solid.

The catalyst carrier is preferably activated so that the mass loss from thermal silica activation is first adjusted to 4.1 percent by weight to 4.3 percent by weight, that in this phase the mass loss rate is highest at 38.5C to 47.5C and that no further mass loss occurs between 134C and 136C and that the mass loss is then adjusted to 0.5 percent by weight to 0.6 percent by weight with further temperature increase, that the mass loss rate in this phase is highest between 420C and 430C, and that no further mass loss occurs from 530C and that the highest temperature reached should not exceed 580C.

The polymer microstructure of the polyethylenes of the invention, such as the polymer chain degree of branching, can be determined by way of IR spectroscopy acc. to J. L. Konig (in Spectroscopy of Polymers ACS Professional Reference Book 1992, pp. 90 to 91) or by way of NMR spectroscopy acc. to J. C. Randall (in ACS Symposium Series 142 (1980), p. 100, as well as ACS Symposium Series 247 (1984), p. 245).

Both measuring methods provide identical results as regards the alkyl group degree of substitution of the macromolecular polymer chains.

The constants of K=6.7×10⁻² and a=0.69 (acc. to M. E. S. Habibe and M. C A Esperidiao in J. Polymer Sci. Part B, Polymer Phys. 33 (1995), pp. 759 to 767) are used to calculate the polymer mass of the polyethylene of the invention determined by viscosimetry.

The process parameters of the fluidized bed polymerization process acc. to the invention, i.e. the reactor temperature, the circulation gas velocity and the effective product retention time in the reactor, as well as the adjustment of defined concentrations of 1-butene and CO₂ in the reaction circulation gas, allow to produce a highly flowable polyethylene grit of a grit flowability improved by a factor of minimum 2 as compared to known polymer grit, for various average polymer particle diameters and at a defined limited polymer grain content of <0.25 mm.

The polymers of the invention are characterized by a gradually higher toughness behavior measured in terms of notched impact strength (15 degrees—test piece with double-V-notch; standard small bar) (DIN 63453).

According to the invention, ultra-high molecular polymers with viscosity numbers up to 3,000 cm³/g are formed.

The polymers of the invention have viscosity numbers from 1,455 to 2,450 cm³/g acc. to ISO 1191, notched impact strength values from 204 to 210 mJ/mm² acc. to DIN 53453 and are hence of a gradually higher grade as compared to known normal ultra-high molecular PE types with 190 to 200 mJ/mm² and viscosity numbers around 2,300 cm³/g. Unlike polymers from some known production processes, the polymers from this invention do not contain any corrosive catalyst residues and they hence do not show any corrosive effect on the processing equipment.

Examples 1 to 5 (Tables 1 and 2) demonstrate the advantages of the process of the invention based on the property parameters of the produced polymers. Example 6 illustrates the method of the invention to activate the catalyst carrier.

### INVENTION EXAMPLES 1 to 5

TABLE 1
Process parameters of the fluidized bed polymerization process

| | | Example | Example | Example | Example | Example |
|---|---|---|---|---|---|---|
| | Unit | no. 1 | no. 2 | no. 3 | no. 4 | no. 5 |
| Reactor temperature | C | 94.1 | 92.8 | 92.6 | 95 | 87 |
| Circulation gas | m/sec. | .75 | .82 | .85 | .82 | .74 |
| velocity | | | | | | |
| 1-butene/ethene | mole/mole | 23 × 10⁻⁴ | 10 × 10⁻⁴ | 8 × 10⁻⁴ | 8 × 10⁻⁴ | 6 × 10⁻⁴ |
| molar ratio | | | | | | |
| Polymer bed mass | tonne | 13.51 | 12.40 | 12.50 | 12.40 | 11.30 |
| Charged ethene mass | tonne/hr. | 3.456 | 3.442 | 3.375 | 3.283 | 3.067 |
| per unit of time | | | | | | |
| Produced | tonne/hr. | 3.409 | 3.392 | 3.324 | 3.237 | 3.025 |
| polyethylene mass | | | | | | |
| per unit of time | | | | | | |
| Catalyst consumption | kg/hr. | .44 | .49 | .58 | .26 | .45 |
| per unit of time | | | | | | |
| Carbon dioxide | ppm | 0 | 3.2 | 4.2 | 2.0 | 1.5 |
| content in reaction | | | | | | |
| circulation gas | | | | | | |

TABLE 2
Characteristic parameters of polymers

| | | Determi- | | | | | |
|---|---|---|---|---|---|---|---|
| | | nation | | | | | |
| | | method, | Example | Example | Example | Example | Example |
| | Unit | standard | no. 1 | no. 2 | no. 3 | no. 4 | no. 5 |
| Viscosity | cm³/g | ISO 1191 | 1,455 | 2,230 | 2,200 | 2,450 | 3,040 |
| number | | | | | | | |
| Density at | g/cm³ | ISO 1183 | .936 | .934 | .935 | .933 | .929 |
| 23 C. (plate) | | DIN 53479 | | | | | |
| Bulk | g/l | DIN 53468 | 504 | 520 | 491 | 500 | 490 |
| density | | | | | | | |
| Flowability | g/sec. | DIN 53492 | 9.67 | 9.74 | 9.26 | 9.77 | 9.70 |
| Average | mm | DIN 53477 | .80 | 1.05 | .85 | .75 | .70 |
| particle | | | | | | | |
| grain size | | | | | | | |
| Particle | % | | 3.3 | 1.3 | 3.2 | 3.9 | 5.9 |
| grain size | | | | | | | |
| <.25 mm | | | | | | | |
| Catalyst | [Ma-ppm] | | 130 to 140 | 140 to 160 | 170 to 180 | 40 to 70 | 100 to 120 |
| residue in | | | | | | | |
| PE powder | | | | | | | |
| Ash | | | | | | | |
| content | | | | | | | |
| SiO₂ | [Ma-ppm] | | 120 to 140 | 140 to 150 | 150 to 170 | 70 to 90 | 90 to 110 |
| content | | | | | | | |
| Cr content | [Ma-ppm] | | 2.1 | 2.3 | 2.8 | 1.3 | 1.8 |
| Polymer | [R/100 C.] | FT-JR | .27 | .24 | .23 | .21 | .1 |
| chain | | C¹³-NMR | | | | | |
| degree of | | | | | | | |
| branching | | | | | | | |
| Melting | | | | | | | |
| behavior | | | | | | | |
| Melting | [C.] | DTA | 130.5; | 130.2 | 131.2 | 132.5 | 132.4 |
| start | | | 131.3 | | | | |
| Melting | [C. | DTA | 141.6 | 141 | 142 | 143 | 143 |
| maximum | | | | | | | |
| Oxidation | | | | | | | |
| behavior | | | | | | | |
| Oxidation | [C] | DTA | 163.4 | 163 | 164 | 164 | 164 |
| start | | | | | | | |
| O₂ addition | [] | DTA | .88 | .87 | .90 | .95 | .92 |
| Yield | [N/mm²] | ISO 527 | 21.2 | 19 | 20 | 20 | 20 |
| stress | | | | | | | |
| Elongation | [%] | ISO 527 | 12.3 | 12.9 | 12.6 | 13.1 | 13.0 |
| Shore D | — | DIN 53505 | 58 | 63 | 63 | 63 | 63 |
| hardness, | | | | | | | |
| 3 secs.- | | | | | | | |
| value | | | | | | | |
| (plate, min. | | | | | | | |
| 6 mm) | | | | | | | |
| Notched | mJ/mm² | DIN 53453 | 209 | 209 | 210 | 204 | 140 |
| impact | | | | | | | |
| strength, | | | | | | | |
| double V | | | | | | | |
| notched | | | | | | | |
| bar (15 | | | | | | | |
| degs.); | | | | | | | |
| standard | | | | | | | |
| small bar | | | | | | | |
| Resistance | [%] | in | 130 | 106 | 108 | 98 | 85 |
| to wear | | conformity | | | | | |
| (relative | | with DIN | | | | | |
| wear to | | 58836 | | | | | |
| Hostalen | | | | | | | |
| GUR 4120 = | | | | | | | |
| 100%, | | | | | | | |
| sand slurry | | | | | | | |
| test 24 | | | | | | | |
| hrs./1,200 | | | | | | | |
| m⁻¹) | | | | | | | |

### EXAMPLE NO. 6

Commercially available amorphous silica, such as that of the Sylopol 955 w type, is activated to produce the chromocene silica catalyst solid so that the mass loss from thermal activation of silica is first adjusted to 4.1 percent by weight to 4.3 percent by weight and so that in this phase the mass loss rate is highest at 38.5C to 47.5C and that no further mass loss occurs from 134C to 136C and that mass loss is adjusted to 0.5 percent by weight to 0.6 percent by weight with further temperature rise and that the mass loss rate is highest at 420C to 430C so that no further mass loss occurs from 530C upward and that the highest reachable temperature does not exceed 580C.

The silica catalyst carrier thus thermally activated is loaded with chromocene in a hydrocarbon slurry as usual so as to adjust the chromium content in the catalyst solid isolated from the hydrocarbon slurry to 1.1 percent by weight of chromium.

### SUMMARY

The invention relates to a process to produce ultra-high molecular polyethylene and to a method to activate the catalyst carrier.

Based on the claimed process parameters of the gas phase fluidized bed process, i.e. reactor temperature, circulation gas velocity and effective retention time in the reactor, and by adjusting and maintaining defined concentrations for 1-butene and CO₂ in the circulation gas and through the use of a specific thermal activation process for the silica carrier of the organochromium compound, highly flowable and ultra-high molecular polyethylene grits with a limited polymer grain content of <0.25 mm are formed. The polymers of the invention are characterized by a gradually higher viscosity and by the absence of corrosive catalyst residues in the polymers.

1. A process to produce ultra-high molecular polyethylene according to the polymerization process in a fluidized bed in the gas phase in the presence of a carrier catalyst solid of chromocene on thermally activated silica whereby the velocity of the reaction circulation gas during the polymerization reaction in the gas phase fluidized bed process is adjusted to between 0.70 m/sec. and 0.88 m/sec., and whereby the polymerization temperature is adjusted to between 85C and 100C and whereby the average retention time, expressed as the ratio between the polyethylene bed mass and the polyethylene mass continuously discharged from the reactor, is adjusted to 3.1 hrs., and whereby a 1-butene concentration in the reaction circulation gas equivalent to a partial pressure ratio 1-butene: ethylene of 2.5·10⁻⁴ mole/mole to 25·10⁻⁴ mole/mole or of 100 ppm to 1,000 ppm 1-butene and a CO₂ content of 1.2 ppm to 10 ppm are adjusted and whereby at the same time wall fouling is avoided in the whole reactor circulation gas system while the fluidized bed densities in the reaction zone as such are maintained constant.

2. A method to activate the catalyst carrier for the process according to claim 1 whereby the silica to produce the chromocene silica catalyst solid is activated so that the mass loss from thermal silica activation is first adjusted to 3.1 percent by weight to 4.8 percent by weight and that in this phase the mass loss rate is highest at 37C to 50C and that from 132C to 138C there is no further mass loss and that the mass loss at further temperature rise is then adjusted to 0.45 percent by weight to 1.90 percent by weight and that in this phase the mass loss rate is highest at 410C to 440C and that no further mass loss occurs from 520C to 540C and that the highest reachable temperature should not exceed 580C, whereby the silica carrier thus activated shall only be loaded with so much chromocene subsequently to thermal carrier activation that the chromium concentration in the dry catalyst solid is adjusted to between 0.9 percent by weight and 1.1 percent by weight Cr.

3. A process according to claim 1 whereby the velocity of the reaction circulation gas is adjusted to 0.74 m/sec. to 0.85 m/sec

4. A process according to claim 1 whereby the polymerization reactor temperature is adjusted to 87C to 95C.

5. A process according to claim 1 whereby a 1-butene concentration equivalent to a partial pressure ratio 1-butene: ethylene of 6.0·10⁻⁴ mole/mole to 11 . 10⁻⁴ mole/mole or of 500 ppm to 800 ppm 1-butene is adjusted in the reaction circulation gas.

6. A process according to claim 1 whereby a CO₂ content of 1.5 ppm to 4.5 ppm is adjusted in the reaction circulation gas.

7. A process according to claim 2 whereby the mass loss from thermal silica activation is first adjusted to 4.1 percent by weight to 4.3 percent by weight and whereby in this phase the mass loss rate is highest at 38.5C to 47.5C and whereby from 134C to 136C there is no further mass loss and whereby the mass loss rate at further temperature rise is adjusted to 5 percent by weight to 0.6 percent by weight and whereby the mass loss rate in this phase is highest at 420C to 430C and whereby no further mass loss occurs from 530C and whereby the highest reachable temperature shall not exceed 580C.
